(19) United States
(12) Patent Application Publication
(10) Pub. No.: US 2006/0220877 A1
(43) Pub. Date: Oct. 5, 2006

(54) Method for making RFID device antennas

(76) Inventors: Scott Wayne Ferguson, Sunnyvale, CA (US); Howard H. Enlow, Munster, IN (US)

Correspondence Address: Jonathan A. Platt;Renner, Otto, Boisselle & Sklar, LLP, Nineteenth Floor, 1621 Euclid Avenue, Cleveland, OH, 44115, US

(21) Appl. No.: 11/415,774

(22) Filed: May 2, 2006

Related U.S. Application Data
(63) Continuation of application No. PCT/US06/10341, filed on Mar. 22, 2006.
(60) Provisional application No. 60/665,756, filed on Mar. 28, 2005.

(51) Int. Cl. G08B 13/14

(52) U.S. Cl. 340/572.7; 340/572.1

(57) ABSTRACT

A method of forming a RFID device includes placing a patterned release layer on an RFID device substrate for use as a stencil. The release layer covers the portions of the RFID device substrate upon which conductive material is not to be placed, in the formation of a patterned layer, such as for formation of an antenna. The release layer may be formed by selectively printing a suitable liquid on portions of the RFID device substrate. Following placement of the release layer, a layer of metal is deposited on the release layer and the open portions of the RFID device substrate. The release layer and the metal overlying the release layer are then removed, leaving the desired pattern of metal of the RFID device substrate (a negative image of the pattern of the release layer).

This application is a continuation under 35 USC 365 of PCT Application No. PCT/US06/10341, filed Mar. 22, 2006, which claims priority under 35 USC 119(e) of U.S. Provisional Application No. 60/665,756, filed Mar. 28, 2005. Both of the above applications are hereby incorporated by reference in their entireties.

### TECHNICAL FIELD

The invention relates to methods for making patterned conductive structures, such as antennas for RIFD devices.

### SUMMARY OF THE INVENTION

According to an aspect of the invention, a method of making a patterned conductive structure, such as an antenna for an RFID device, includes placing a release layer on the substrate to cover portions of the substrate where the pattern is not to extend, depositing electrically conductive material over the substrate and release layer, and then removing the release layer and the conductive material overlying the release layer, to leave a patterned conductive material.

According to another aspect of the invention, a method of forming an RFID device includes the steps of: placing a patterned release layer on an RFID device substrate, wherein the release layer leaves uncovered portions of the substrate upon which a patterned conductive layer is to be formed; depositing a layer of conductive material onto the release layer and the uncovered portions of the substrate; and removing the release layer and an overlying portion of the conductive material that overlies the release layer, thereby leaving a remaining portion of the conductive material as the patterned conductive layer on the uncovered portions of the substrate.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

In the annexed drawings, which are not necessarily to scale:

FIG. 1 is an oblique view of an RFID device that may be produced in accordance with the method of the present invention;

FIG. 2 is a high-level flow chart of a method of making a patterned conductive layer, in accordance with the present invention;

FIG. 3 is an oblique view illustrating a first step of the method of FIG. 2;

FIG. 4 is a partial sectional view along section 4-4 of FIG. 3;

FIG. 5 is a partial sectional view illustrating a second step of the method of FIG. 2;

FIG. 6 is an oblique view illustrating a third step of the method of FIG. 2;

FIG. 7 is a partial sectional view along section 7-7 of FIG. 3;

FIG. 8 is a schematic illustration showing one embodiment of a system for carrying out the method of FIG. 2;

FIG. 9 is a schematic illustration showing part of an alternate embodiment of a system for carrying out the method of FIG. 2; and

FIG. 10 is a schematic illustration showing part of another alternate embodiment of a system for carrying out the method of FIG. 2.

### DETAILED DESCRIPTION

A method of forming a RFID device includes placing a patterned release layer on an RFID device substrate for use as a stencil. The release layer covers the portions of the RFID device substrate upon which conductive material is not to be placed, in the formation of a patterned layer, such as for formation of an antenna. The release layer may be formed by selectively printing a suitable liquid on portions of the RFID device substrate. Examples of suitable such liquids include suitable low-volatile oils, and suitable resins. Following placement of the release layer, a layer of metal is deposited on the release layer and the open portions of the RFID device substrate. The release layer and the metal overlying the release layer are then removed, leaving the desired pattern of metal of the RFID device substrate (a negative image of the pattern of the release layer). All or parts of the process may be performed in a vacuum environment. Thus a desired metal pattern, such as a pattern including an antenna, may be simply and inexpensively formed upon the RFID device substrate.

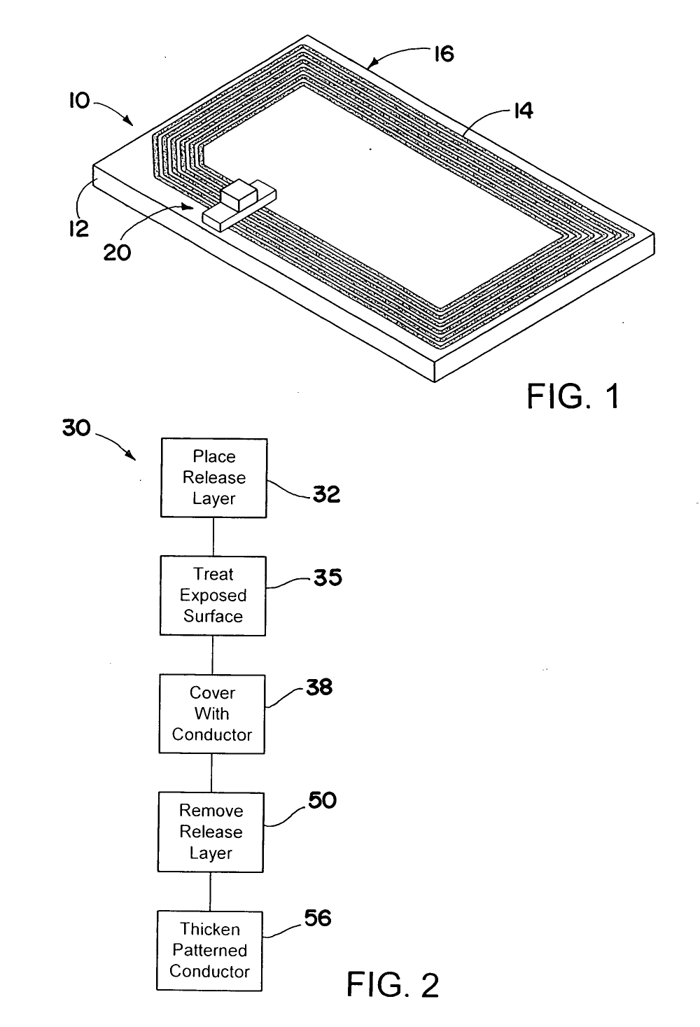

Referring initially to FIG. 1, a RFID device 10 includes an RFID device substrate 12 with a patterned conductive layer 14 thereon. The RFID device substrate 12 may include any of a variety of suitable materials. Examples of suitable materials include polymer materials such as polyethylene terephthalate (PET), poly propylene (PP), or poly carbonate (PC), or other suitable polymer materials. Alternatively, the RFID device substrate 12 may include a suitable non-polymeric material, such as paper. The substrate material may be a web stock or a sheet stock material, such as may be suitable for use in roll-to-roll or other manufacturing process operations.

The patterned conductive layer 14 may include a metal such as aluminum, copper, nickel, gold, silver, platinum, or palladium. Alternatively, it will be appreciated that suitable non-metallic electrical conductors may be employed.

The patterned conductive layer 14 includes an antenna 16, capable of receiving and/or transmitting information when the RFID device 10 is employed as a RFID tag. The RFID device 10 includes a RFID chip or circuitry 20, which is operatively coupled to the antenna 16. The antenna 16 may be used to transmit information stored in the RFID chip or circuitry 20. In addition, the antenna 16 and the RFID chip or circuitry 20 may be configured such that the antenna 16 may be energized by exposure to a suitable excitation signal, to thereby trigger and/or provide energy for transmission of information in the RFID chip or circuitry 20.

The RFID device 10 may also include additional upper layers and/or additional lower layers. Such additional layers may include adhesive layers, printable layers, and/or layers to protect components of the RFID device 10 from dirt, moisture, or other hazards.

As described in greater detail below, the patterned conductive layer 14 may be formed by first placing a negative-image release layer on the RFID device substrate 12. A layer of conductive material is then placed on the device substrate and the release layer. After the release layer is removed, the patterned conductive layer 14 remains on the RFID device substrate 12.

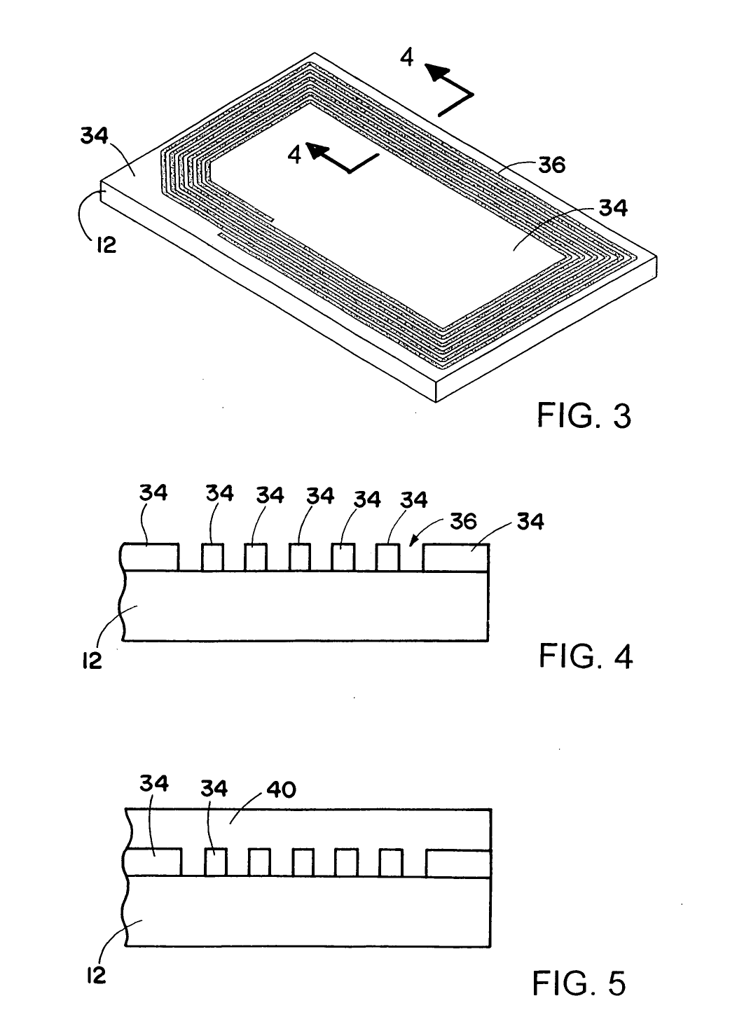

Referring now to the flowchart in FIG. 2, the above method of forming a RFID device is discussed. In step 32 of a method 30, a release layer 34 (FIGS. 3 and 4) is placed on the RFID device substrate 12. The release layer 34 may be a release material such as a liquid selectively placed on parts of the RFID device substrate 12, in a negative image for the desired for the arrangement of the patterned conductive layer 14 (FIG. 1).

The release layer liquid may be any of a variety of suitable liquids, such as suitable oils or resins. An example of a suitable oil is an oil selected from a family of oils sold under the trademark FOMBLIN. Such oils include carbon, oxygen, and fluorine. Such oils have the following characteristics: high chemical stability; high thermal stability; high density; non-flammable; low surface tension; soluble only using highly fluorinated solvents; excellent lubricating and dielectric properties, low volatility and good compatibility with plastics, elastomers and metals over a wide range of temperatures; a high resistance to radiation; and low toxicity. Examples of suitable resins include polymeric release materials such as styrene polymers, acrylic resins, and blends thereof. Other possible release materials include water-soluable resins, printable resist materials, suitable inks, cellulosics, waxy materials, gums, gels, and mixtures thereof. Further information regarding suitable release materials may be found in U.S. Pat. Nos. 3,988,494; 5,549,774; 5,624,076; 5,629,068; 5,650,248; 6,068,691; and 6,398,999, the figures and descriptions of which are hereby incorporated by reference.

It will be appreciated that only some suitable materials for the release layer 34 have been described above. More broadly, the release layer 34 may be made of any of a variety of suitable materials that may be selectively applied upon surfaces of the RFID device substrate 12 which are not to be part of the patterned conductive layer 14, and which may be removed after depositing of a layer of conductive material.

The liquid may be placed on the RFID device substrate 12 by any of a variety of suitable methods, such as by suitable printing methods. The printing may be a pad printing technique such as flexoprinting. Alternatively or in addition, other printing methods, such as roto gravure printing, offset gravure printing, digital printing, screen printing, or inkjet printing may be utilized.

As another alternative, the release layer 34 may be patterned by placement of a mask against the substrate 12, with openings in the mask corresponding to the desired locations for the material of the release layer 34. Material for the release layer 34 may then be sprayed onto the substrate 12, with the mask providing suitable patterning.

The release layer 34 may have a thickness on the order of anywhere from microns to hundredths of microns. It will be appreciated that other suitable thicknesses may alternatively be utilized.

The printing may be performed within a vacuum chamber, in order to facilitate drying or evaporation of some of the release layer liquid after printing. The entire printer may itself be within the vacuum chamber, or alternatively only a portion of the printer, such as a nozzle or print head, may protrude into the vacuum chamber. As another alternative, the substrate 12, with the release layer 34 thereupon, may be placed in a vacuum chamber after the printing. The pressure within such a vacuum chamber may be any suitable pressure, for example between about 0.13 to 1.3 Pa (10⁻² to 10⁻³ torr). The vacuum chamber utilized may be the same chamber in which a subsequent metallization is performed. Further information regarding use of oil in vacuum processes may be found in U.S. Pat. Nos. 4,749,591 and 4,903,165, the descriptions and figures of which are incorporated by reference.

Although the release layer 34 has been described above as a liquid selectively placed on the RFID device substrate 12, it will be appreciated that the release layer 34 may be dried or cured, and thus transformed into a solid, before subsequent steps. As another alternative, the release layer 34 may itself be a suitable solid stencil, placed upon the RFID device substrate 12. The solid stencil may be made of a suitable material such as PET. The solid stencil may be laminated onto the RFID device substrate 12. The solid stencil and the RFID device substrate 12 may both be parts of respective roll material, with the placement of the release layer 34 on the RFID device substrate 12 being part of a roll-to-roll operation. Similarly, the liquid for the release layer 34 may be placed on the RFID device substrate 12 as part of a roll-to-roll operation. The other steps described below of the method 30 may also be performed in the same or in different roll operations.

In step 35, which may be omitted, an exposed substrate surface 36 (FIGS. 3 and 4) of the RFID device substrate 12, the portion of the surface of the RFID device substrate 12 not covered by the release layer 34 (FIGS. 3 and 4), is treated. This treatment may include bringing chemicals into contact with the exposed surface 36, or otherwise treating the surface, so as to change its adherence properties. For example, chromium or nickel may be deposited by sputtering or evaporation to facilitate adherence of another metal to be deposited in a later step. Alternatively, the exposed substrate surface 36 may be suitably roughened by chemical and/or physical methods.

As noted above, step 35 may be considered optional, in that it may be omitted from the method 30 if no surface treatment is required. As another alternative, the entire surface of the substrate 12 may be treated to improve adherence, prior to the deposition or forming of the release layer 34.

In step 38, as illustrated in FIG. 5, the RFID device substrate 12 and the release layer 34 are covered or coated with a layer of conductive material 40 in the areas of the RFID device substrate 12 that are not covered by the release layer 34 (the exposed substrate surface 36), the conductive material 40 is directly in contact with the RFID device substrate 12. However, in the areas covered by the release layer 34, the conductive material layer overlies the release layer 34, forming an overlying portion 46 of the conductive material layer 40.

The conductive material may have any suitable thickness, an exemplary range of suitable thickness being from about 0.1 microns to about 50 microns. As a practical matter, it may be desirable to limit the thickness of conductive material added in a single process step, so as to allow faster processing of material. The speed at which material may be added may be limited by the need to remove from the substrate 12 heat generated by the material deposition process. Thus the amount of material added in a single step may be limited, for example, to 0.1 to 1 micron. Still the range of conductor thickness that may be deposited may be suitable for use as an antenna, such as the antenna 16 shown in FIG. 1. Alternatively, the conductive material layer 40 may have a thickness that is suitable for use as a seed material for later thickening of the patterned conductive layer 14, such as by electroplating. For use as a seed layer, the conductive material layer 40 may have a thickness of up to about 3 microns. As another alternative, also discussed further below, multiple depositions may be employed to thicken the conductive material layer 40. These multiple depositions may involve re-registration and re-deposition of the release layer 34. Alternatively, the same release layer 34 may be utilized for multiple depositions.

The conductive material may be deposited by any of a wide variety of suitable deposition methods. Among the deposition methods that may be utilized are vacuum deposition methods such as chemical vapor deposition or physical vapor deposition. Sputtering may also be used to deposit a metal layer. It may also be possible to use other types of methods such as printing or spraying of a material such as a conductive ink, containing a suitable metal or other conductive material.

Vacuum deposition of material may be accomplished in the same vacuum chamber that the printing of the release layer 34 occurred in, or that the substrate was later moved into.

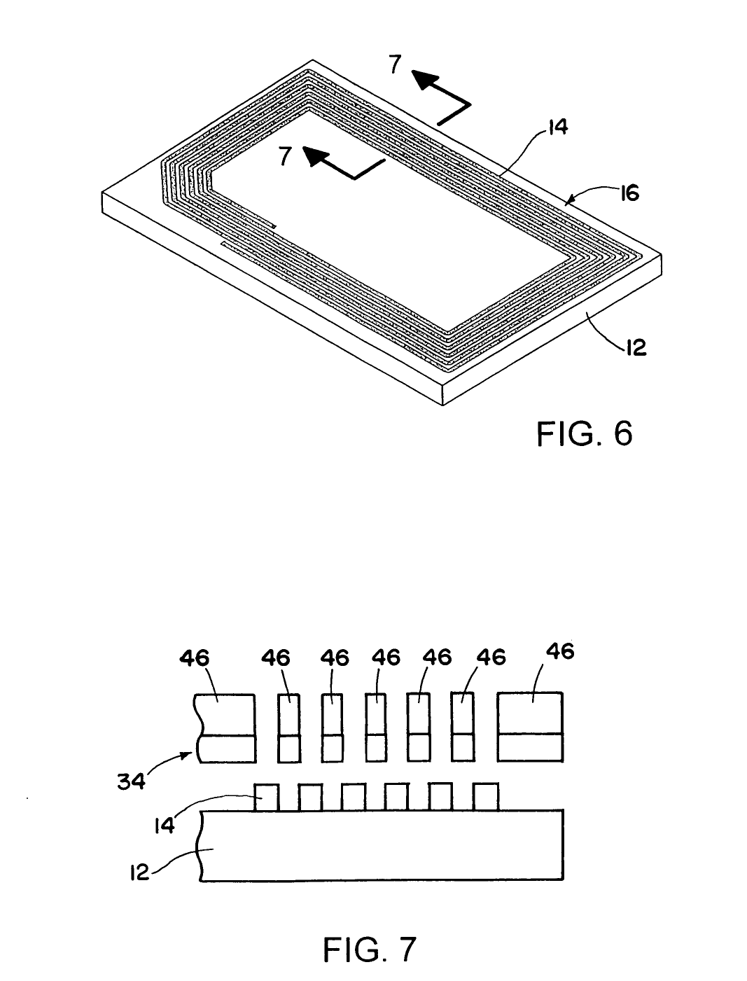

Referring now in addition to FIGS. 6 and 7, the release layer 34 and the overlying portion 46 of the conductive material layer 40 are removed in step 50, leaving the patterned conductive layer 14 that includes the antenna 16.

The release layer 34 may be removed by any of a variety of suitable methods, such as physical removal of the release layer, such as by pulling the release layer 34 away from the RFID device substrate 12, or by spraying a liquid along the substrate 12 to cause the release layer 34 and the overlying conductive material 32 to separate from the RFID device substrate 12.

Alternatively or in addition, chemical removal methods, such as application of a solvent that dissolves away or reduces adherence of the release layer 34 to the RFID device substrate 12, may be employed. It will be appreciated that a wide variety of solvents may be used, depending upon the material of the release layer 34 (which is to be removed), and the material of the conductive layer 40 (which is to be left partially intact). Examples of suitable solvents include highly fluorinated solvents (for removing oils such as FOMBLIN); acetone, ethyl acetate, and toluene (for removing certain polymeric release layers); water (for removing water-soluble materials, such as water-soluble inks or resins); and potassium hydroxide (for removing some types of resists).

If desired, in step 56, the patterned conductive layer 14 may be thickened such as by electroplating or by multiple deposition steps. It will be appreciated that step 56 is an optional step in that there may be suitable thickness in the patterned conductive layer 14 without resorting to thickening processes.

In one embodiment of the thickening of step 56, electroplating may be used to thicken the patterned conductive layer 14. Electroplating is suitable for use with copper, for example. The substrate 12 and the patterned conductive layer 14 may be immersed in a suitable electroplating solution, in order to cause deposition of additional conductive material such as conductive metal. It will be appreciated that multiple immersions in multiple plating baths may be desirable. Suitable steps, such as rinsing and drying, may be performed after the immersion, to suitably prepare the RFID device 10 for further processing steps.

In another embodiment of the thickening, multiple deposition operations may be used to thicken the conductive layer 14. Where appropriate, it may be possible to use the same release layer 34 for multiple depositions of conductive material. Multiple deposition operations may be suitable combined in a single process, such as in a single roll-to-roll process. Even when multiple roll-to-roll processes are used in order to obtain a desired thickness of conductive material, it will be appreciated that some types of materials for the release layer 34 may be suitably undisturbed by process steps such as re-rolling, so that the release layer 34 may be used in multiple roll-to-roll processes.

As an alternative, multiple depositions may involve multiple iterative processes as described above (depositing the release layer, depositing the conductive material, and removing the release layer and overlying conductive material). In the second and all subsequent such depositions, re-registrations of the device will be needed so that the second and subsequent applications of the release layer 34 are aligned with the patterned conductive material 14 already formed. Some misalignment between the multiple depositions is to be expected, and such misalignments may result in rough or uneven edges to the conductive material pattern 14 formed by the multiple depositions of conductive material. Since rough or uneven edges may deleteriously affect performance of an antenna, it may be desirable to use processes such as selective ablating or polishing to provide smoother edges to the conductive material pattern 14. Such smoothing may produce, for example, sharper rectangular cross-section corners to various parts of the patterned conductive material 14.

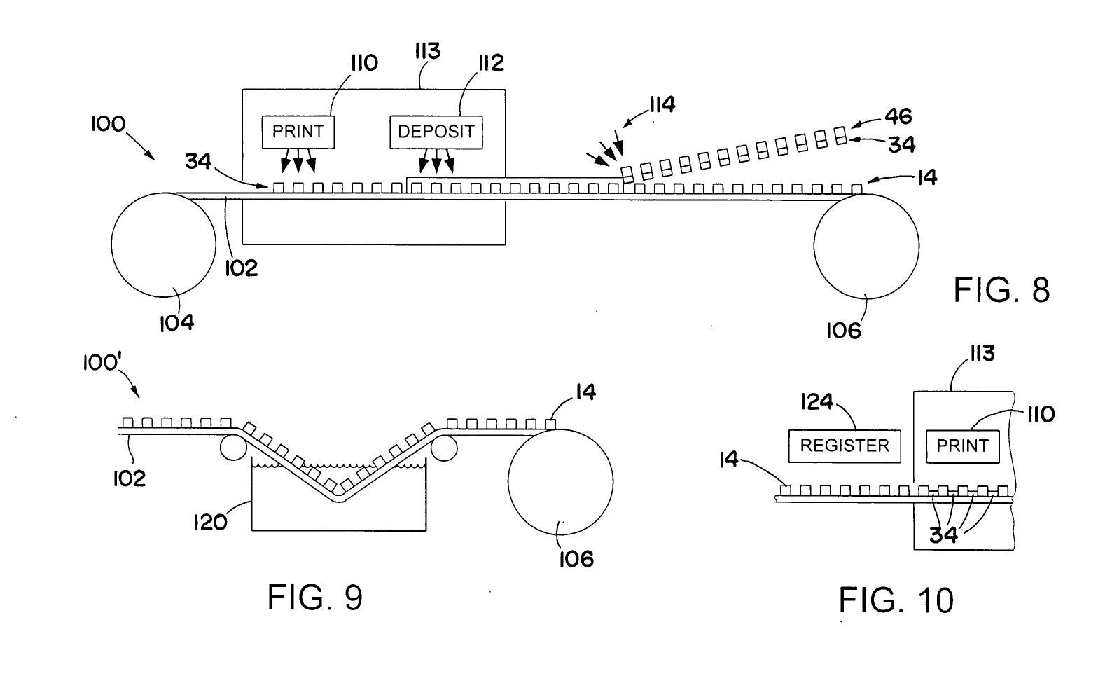

FIG. 8 shows a schematic representation of a system 100 for performing at least some of the steps of the method 30, as parts of a roll-to-roll operation. The system 100 packs on an RFID substrate material 102, which proceeds from a supply roll 104 to a take-up roll 106.

A printer 110 forms the release layer 34 on the substrate material 102. Then a deposition device 112 covers the substrate material 102 and the release layer 34 with the conductive material layer 40. The printer 110 and the deposition device 112 are located within a vacuum chamber 113. Alternatively, as discussed above, all or part of the printer 110 may be located outside of the vacuum chamber 113.

Finally, a release layer removal device 114 separates the release layer 34 and the overlying conductive material 46 from the substrate material 102 and the patterned conductive layer 14 that remains on the substrate material 102.

Multiple of the parts of the system 100 may be incorporated into a single device. Suitable machines for performing at least some of the functions may be obtained from Aerre Machines SrL of Robbiate, Italy.

FIG. 9 shows a schematic representation of a portion an alternate embodiment system 100′, having an electroplating bath 120. The substrate 102 passes though the electroplating bath 120 to thicken the conductive pattern 14.

FIG. 10 shows a schematic representation of another alternate embodiment system 100″. The system 100″ has a registration station 124 located upstream of the printer 110. The registration station 124 registers location of existing conductive patterns 14 on the substrate 102, to allow printing of the release layer 34 at suitable locations so that the conductive patterns 14 may be thickened by a downstream conductive material deposition, and removal of the release layer 34.

It will be appreciated that other steps may be taken to separate individual RFID devices 10 from a web of such devices on a single substrate such as the RFID device substrate 102. In addition, other suitable steps may be employed in assembly of the RFID devices 10, such as placement of chips or interposers, and coupling of various additional layers.

The above methods advantageously allow low-cost, efficient manufacture of RFID devices. In particular, the methods described above may allow for antennas having greater conductivity, reduced thickness, and/or reduced cost, in comparison with antennas made from patterned conductive inks.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A method of forming an RFID device, the method comprising:
placing a patterned release layer on an RFID device substrate, wherein the release layer leaves uncovered portions of the substrate upon which a patterned conductive layer is to be formed;
depositing a layer of conductive material onto the release layer and the uncovered portions of the substrate; and
removing the release layer and an overlying portion of the conductive material that overlies the release layer, thereby leaving a remaining portion of the conductive material as the patterned conductive layer on the uncovered portions of the substrate.

2. The method of claim 1, wherein the placing the release layer includes patterned printing of a liquid release layer on the substrate.

3. The method of claim 2, wherein the patterned printing includes patterned printing of an oil on the substrate as the liquid release layer.

4. The method of claim 2, wherein the patterned printing includes patterned printing a resin on the substrate as the liquid release layer.

5. The method of claim 2, wherein the patterned printing includes printing in a vacuum.

6. The method of claim 2, further comprising transforming the liquid release layer into a solid before the depositing.

7. The method of claim 1, wherein the placing the release layer includes placing a solid stencil on the substrate.

8. The method of claim 1, further comprising treating at least a portion of the RFID device substrate to increase adherence of the conductive material on the RFID device substrate.

9. The method of claim 8, wherein the treating occurs after the placing the patterned release layer and before the depositing.

10. The method of claim 1, wherein the depositing includes depositing with a vacuum deposition method.

11. The method of claim 1, wherein the depositing includes depositing a layer of conductive ink.

12. The method of claim 1, wherein the depositing includes depositing to a thickness of 0.1 microns to 50 microns.

13. The method of claim 1, wherein the depositing includes multiple deposition steps.

14. The method of claim 1, wherein the method includes multiple iterations of the placing, the depositing, and the removing.

15. The method of claim 14, further comprising selective ablating or polishing the conductive pattern after the multiple iterations.

16. The method of claim 1, further comprising, after the removing, electroplating to increase thickness of the patterned conductive layer.

17. The method of claim 1, wherein the substrate includes a polymer material.

18. The method of claim 1, wherein the substrate includes paper.

19. The method of claim 1, wherein the removing includes physically removing the release layer.

20. The method of claim 1, wherein the removing includes chemically removing the release layer.

21. The method of claim 1, wherein the patterned conductive layer includes an antenna of an RFID device.

22. A system for performing the method of claim 1.
